(19) United States
(12) Patent Application Publication
(10) Pub. No.: US 2016/0362776 A1
(43) Pub. Date: Dec. 15, 2016

(54) SPRAYED COATING FORMING METHOD

(71) Applicant: NISSAN MOTOR CO., LTD., Yokohama-shi (JP)

(72) Inventors: Akira Shimizu, Kanagawa (JP); Yoshitsugu Noshi, Kanagawa (JP); Daisuke Terada, Kanagawa (JP); Kiyokazu Sugiyama, Kanagawa (JP); Takafumi Watanabe, Kanagawa (JP)

(73) Assignee: Nissan Motor Co., Ltd., Kanagawa (JP)

(21) Appl. No.: 15/121,664

(22) PCT Filed: Jan. 22, 2015
(86) PCT No.: PCT/JP2015/051628

§ 371 Date: Aug. 25, 2016

(30) Foreign Application Priority Data
Feb. 28, 2014 (JP) 2014-038240

(51) Int. Cl. C23C 4/12; F02F 1/00; F02F 7/00

(52) U.S. Cl. CPC C23C 4/12; F02F 7/0007; F02F 1/004; F02F 2200/00

(57) ABSTRACT

A sprayed coating forming method of forming a sprayed coating includes pre-heating a cylinder block defining a plurality of cylinders, supplying air into an enclosure that houses the cylinder block, inserting a spray gun sequentially into cylinder bores formed in the cylinder block while discharging the air at least from one side of the cylinder block, and spraying droplets of a molten metal onto an inner surface of each of the cylinder bores. The spraying includes spraying one of the cylinder bores first, then next spraying another of the cylinder bores that has at least one cylinder disposed between the another of the cylinder bores and the one of the cylinder bores sprayed first. The air flows around the cylinder block and also flows inside the cylinder bores.

### CROSS-REFERNCE TO RELATED APPLICATIONS

The present application is a national stage application of PCT/JP2015/051628 filed Jan. 22, 2015, and claims foreign priority to Japanese Patent Application No. 2014-038240 filed Feb. 28, 2014, the contents of which are incorporated herein in their entirety.

### BACKGROUND

Technical Field

The present invention relates to a sprayed coating forming method of forming a sprayed coating on an inner surface of a cylinder bore.

Related Art

Bore spraying is a method of forming a coating on an inner surface of a cylinder bore of a cylinder block for an automobile or the like by spraying a metal or a ceramic, then smoothing its surface by honing, and thereby forming a sliding surface for a piston ring. The bore spraying is applied as a technique for improving fuel efficiency.

To improve adhesion of such a coating to a base material, a cylinder block is subjected to heating (this heating is called pre-heating) before spraying (see Non Patent Literature 1).

Non Patent Literature 1: Journal of the Japan Institute of Metals, Vol. 71, No. 3 (2007), 354-360

### SUMMARY

In spraying of droplets of a molten metal material, residual particles, soot, or splattered droplets that fail to adhere to a sprayed surface may be captured in a sprayed coating. To avoid this, the splattered droplets and the like are discharged to the outside of the cylinder block by conducting exhaust ventilation from a lower side of the cylinder block.

However, the inner surface of the cylinder bore, i.e., the spray target surface is cooled by exhaust airflow that flows in and out of the cylinder block, and a pre-heating temperature of the cylinder block drops as a consequence. For this reason, the adhesion of the sprayed coating to the inner surface of the cylinder bore is deteriorated.

One or more embodiments of the present invention provides a sprayed coating forming method which is capable of suppressing a drop in pre-heating temperature of a cylinder block and enhancing adhesion of a sprayed coating to an inner surface of a cylinder bore.

According to a sprayed coating forming method of one or more embodiments of the present invention, a cylinder bore located while leaving a space of at least one cylinder from a cylinder bore first sprayed is sprayed next.

### BRIEF DESCRIPTION OF THE DRAWINGS

FIG. 1 is a perspective view showing a sprayed coating formation apparatus for carrying out a method according to one or more embodiments of the present invention.

FIG. 2 is a diagram showing airflow when exhaust ventilation is conducted by the sprayed coating formation apparatus for carrying out a method according to one or more embodiments of the present invention.

FIG. 3 is a perspective view showing a state before a spray gun is inserted into a cylinder bore.

FIG. 4 is a schematic diagram showing an aspect of forming a sprayed coating by spraying droplets onto an inner surface of a cylinder bore.

FIG. 5 is a characteristic chart showing a relation between a pre-heating temperature and adhesion.

FIG. 6 is a characteristic chart showing changes in cylinder block temperature after pre-heating over time, which are observed in a first cylinder bore and a fourth cylinder bore.

FIG. 7 is a diagram showing an order of spraying cylinder bores.

### DETAILED DESCRIPTION

Embodiments of the present invention will be described below in detail with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

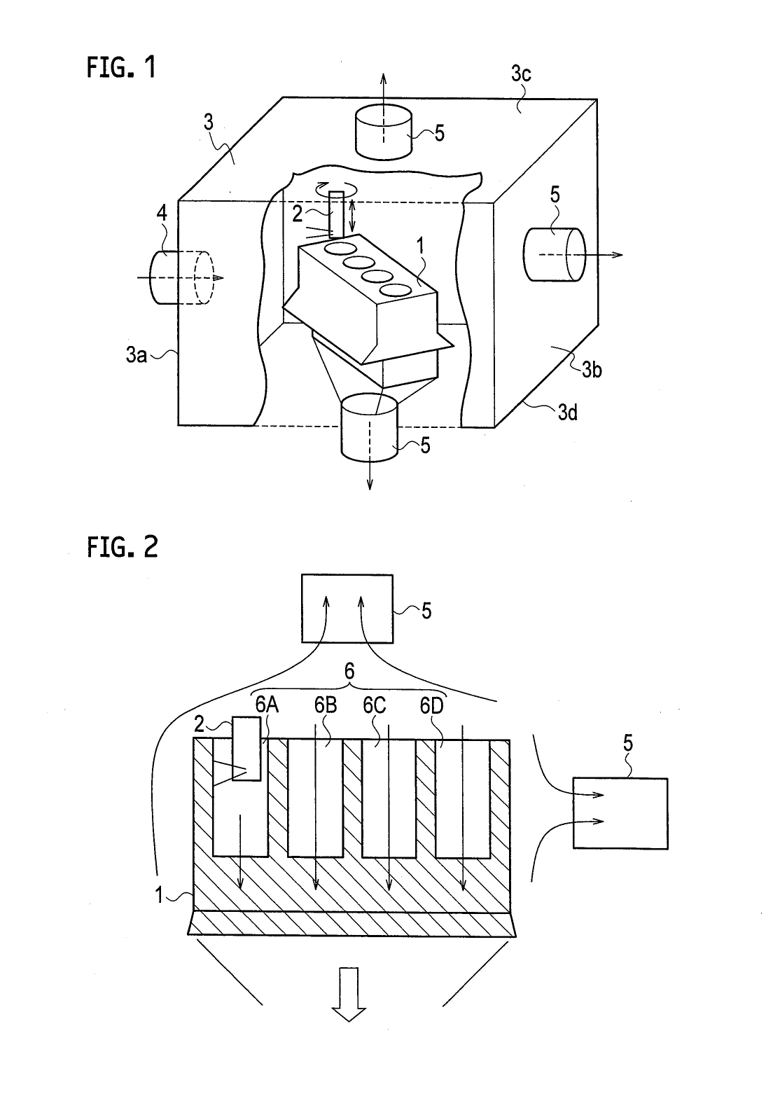

FIG. 1 is a perspective view showing the entirety of a sprayed coating formation apparatus for carrying out a sprayed coating forming method according to one or more embodiments of the present invention. The sprayed coating formation apparatus has a configuration in which a cylinder block 1 and a spray gun 2 for forming a sprayed coating on an inner surface of each cylinder bore in the cylinder block 1 are disposed in an enclosure 3 for exhaust ventilation.

The enclosure 3 is formed as a rectangular box having a shape of a hexahedron, for example. However, the shape of the enclosure 3 is not limited to the shape of FIG. 1. When FIG. 1 is viewed from the front, for example, an intake duct 4 for air intake is provided on a left side surface 3a. Meanwhile, exhaust ducts 5 for exhaust ventilation are provided on a right side surface 3b, an upper surface 3c, and a lower surface 3d.

Air to be supplied into the enclosure 3 is introduced to the intake duct 4. The air inside the enclosure 3 is discharged from the exhaust ducts 5 to the outside of the enclosure 3. Of droplets of a molten metal material, residual particles, soot, or splattered droplets that fail to adhere to a sprayed surface are discharged from these exhaust ducts 5 together with the air to be discharged.

The air supplied from the intake duct 4 into the enclosure 3 flows as indicated with arrows in FIG. 2. The air flows around the cylinder block 1 and also flows inside cylinder bores 6 (6A, 6B, 6C, and 6D) formed in the cylinder block 1.

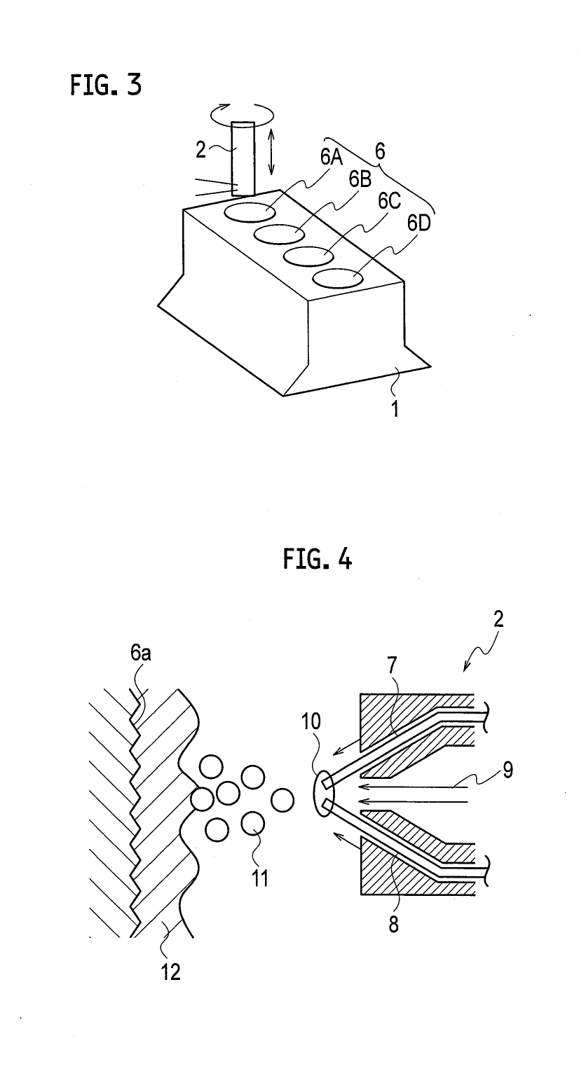

The spray gun 2 is an arc spray gun as shown in FIG. 3 and FIG. 4. This arc spray gun 2 is configured to: poke out a wire 7 which is made of a metal material and serving as a positive electrode and a wire 8 which is likewise made of the metal material and serving as a negative electrode, continuously in such a manner that the wires 7 and 8 are brought close to each other at a tip end of a nozzle; and generate an arc 10 by supplying an atomizing gas 9. The wires 7 and 8 are melted by this arc 10 and are formed into droplets 11 which are sprayed particles. The droplets 11 adhere to an inner surface 6a of each cylinder bore 6, thereby forming a sprayed coating 12.

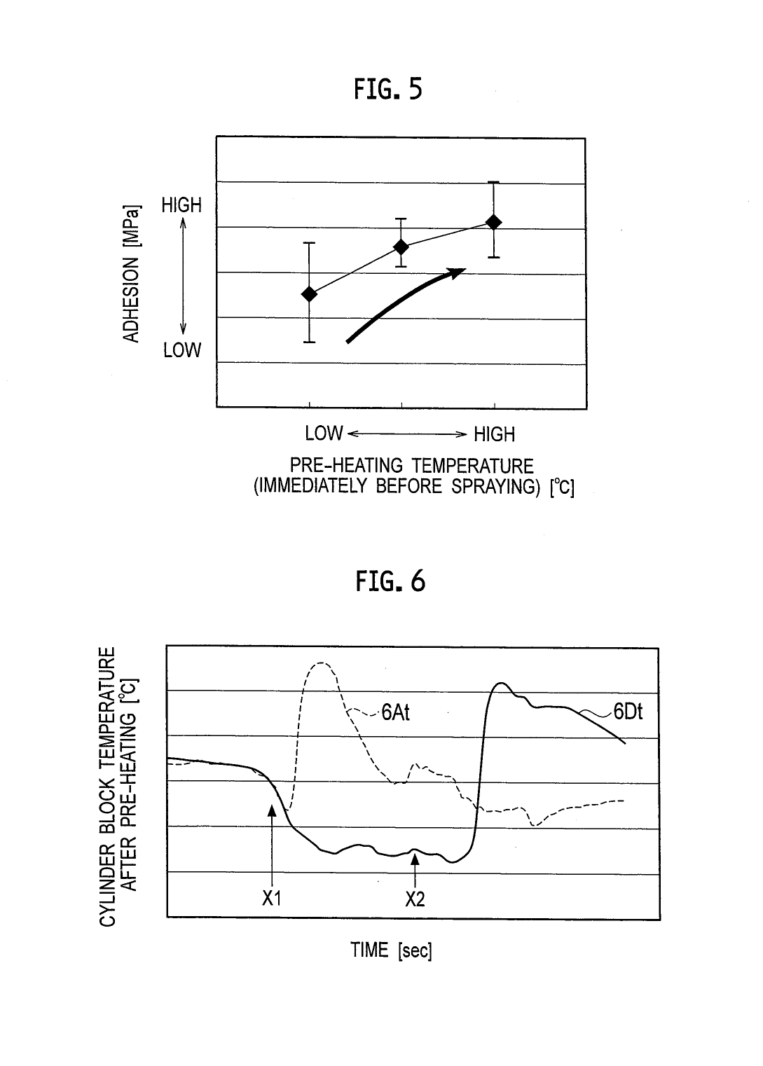

It has been known that adhesion of the sprayed coating 12 to be formed on the inner surface 6a of the cylinder bore 6 depends on a pre-heating temperature for heating the cylinder block 1 prior to the spraying. As shown in FIG. 5, as the pre-heating temperature of the cylinder block 1 becomes higher, the adhesion of the sprayed coating 12 grows larger in accordance with the rise in the pre-heating temperature.

A sequence to form the coatings on the multiple cylinder bores 6A to 6D is important for forming the sprayed coatings 12 by spraying the molten metal droplets 11 onto the inner surfaces 6a of the cylinder bores 6. Here, the cylinder bores 6 formed in the cylinder block 1 for an in-line four-cylinder engine are defined as a first cylinder bore 6A, a second cylinder bore 6B, a third cylinder bore 6C, and a fourth cylinder bore 6D sequentially from one end, for example.

After this cylinder block 1 is disposed in the enclosure 3, the cylinder block 1 is pre-heated by heating means such as a heater. Then, the inside of the enclosure 3 is subjected to exhaust ventilation. Hence, the airflow occurs as illustrated in FIG. 2. Next, as for the order of spraying, if the first cylinder bore 6A, the second cylinder bore 6B, the third cylinder bore 6C, and the fourth cylinder bore 6D are sprayed in this order from one end, the fourth cylinder bore 6D is continuously deprived of the pre-heat due to the exhaust airflow. For this reason, the cylinder bore later in the order of spraying is sprayed in the state deprived of more heat from the pre-heating temperature.

FIG. 6 shows changes in cylinder block temperature after pre-heating over time, which are observed in the first cylinder bore 6A and the fourth cylinder bore 6D. In FIG. 6, a line 6At indicates the change in temperature of the first cylinder bore 6A while a line 6Dt indicates the change in temperature of the fourth cylinder bore 6D. In the meantime, X1 shows a point of the spraying on the first cylinder bore 6A while X2 shows a point of the spraying on the fourth cylinder bore 6D. As clear from FIG. 6, regarding the fourth cylinder bore 6D to be sprayed at the end, its cylinder block temperature after pre-heating drops over time. For this reason, the sprayed coating 12 on the fourth cylinder bore 6D is sprayed in the state of the temperature dropped substantially below the pre-heating temperature, whereby its adhesion is deteriorated as a consequence.

In one or more embodiments of the present invention, the order of spraying the multiple cylinder bores 6A to 6D is set as described below, so as to avoid a sudden drop in cylinder block temperature after the pre-heating due to the exhaust ventilation. Specifically, the cylinder bore located while leaving a space of at least one cylinder from the cylinder bore first sprayed is sprayed next.

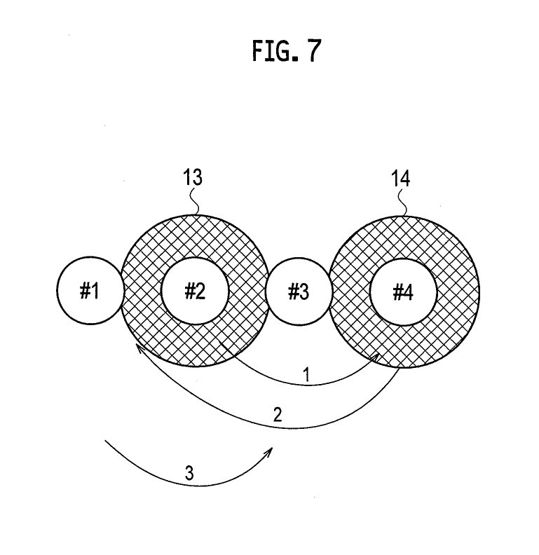

To be more precise, as shown in FIG. 7, the second cylinder bore 6B is first sprayed. In FIG. 7, the first cylinder bore 6A is indicated with #1, the second cylinder bore 6B is indicated with #2, the third cylinder bore 6C is indicated with #3, and the fourth cylinder bore 6D is indicated with #4, respectively. Meanwhile, the spraying order is indicated with 1, 2, 3, and 4, respectively.

The spray gun 2 is inserted deep into the second cylinder bore 6B from a cylinder head surface side thereof. Simultaneously, the molten metal droplets 11 are sprayed onto the inner surface of the cylinder bore. The sprayed coating 12 is formed by spraying and depositing the metal droplets 11 on the inner surface of the cylinder bore. During the spraying, residual particles, soot, or splattered droplets 11 that fail to adhere to the inner surface of the cylinder bore are discharged to the outside of the enclosure 3 through the exhaust ducts 5 by the exhaust ventilation. Thus, it is possible to avoid deterioration in quality of the sprayed coating 12.

When the second cylinder bore 6B is sprayed, the first cylinder bore 6A and the third cylinder bore 6C, which are the cylinder bores located on two sides, are heated by the heat in the spraying. In FIG. 7, shaded regions represent heat input regions 13 and 14 in the spraying. Accordingly, it is possible to suppress a drop in pre-heating temperature of the cylinder block 1 over time.

Next, the fourth cylinder bore 6D located while leaving a space of one cylinder from the second cylinder bore 6B is sprayed. Hence, the adjacent third cylinder bore 6C is heated by the heat in the spraying. Subsequently, the first cylinder bore 6A located while leaving a space of two cylinders from the fourth cylinder bore 6D is sprayed. When the first cylinder bore 6A is sprayed, the first cylinder bore 6A is in the heated state by the heat input in the earlier spraying on the second cylinder bore 6B. Thus, a drop in in-bore temperature of the first cylinder bore 6A is suppressed.

And finally, the third cylinder bore 6C located while leaving a space of one cylinder from the first cylinder bore 6A is sprayed. When the third cylinder bore 6C is sprayed, the third cylinder bore 6C is in the heated state by the heat input in the spraying on the fourth cylinder bore 6D and the heat input in the spraying on the second cylinder bore 6B. Thus, a drop in in-bore temperature of the third cylinder bore 6C is suppressed.

By performing the spraying on the cylinder bores 6A to 6D in the above-described order, it is possible to avoid a drop in temperature of the cylinder block after the pre-heating due to the exhaust ventilation, and to enhance the adhesion of the sprayed coatings 12 formed on all the cylinder bores 6A to 6D.

According to a sprayed coating forming method according to one or more embodiments of the present invention, the cylinder bore located while leaving the space of at least one cylinder from the cylinder bore first sprayed is sprayed. Thus, the cylinder bores located on two sides of the cylinder bore first sprayed are heated by the heat of the first spraying. For this reason, by determining the cylinder located while leaving the space of at least one cylinder to be sprayed next, it is possible to suppress the drop in pre-heating temperature as compared to the case of spraying the cylinder bores sequentially from one end. Accordingly, it may be possible to enhance the adhesion of the sprayed coatings 12 formed on the inner surfaces of the cylinder bores 6.

Meanwhile, according to a sprayed coating forming method according to one or more embodiments of the present invention, the second cylinder bore 6B of the in-line four-cylinder engine is first sprayed, and then the fourth cylinder bore 6D, the first cylinder bore 6A, and the third cylinder bore 6C thereof are sprayed in this order. Thus, the pre-heating temperature of the cylinder block 1 that would otherwise gradually drop over time can be recovered by the heat input in the spraying on each cylinder bore. Thus, it is possible to suppress a sudden drop in temperature of the in-bore temperature of each of the cylinder bores 6A to 6D.

Moreover, according to a sprayed coating forming method according to one or more embodiments of the present invention, residual particles, soot, or splattered droplets that fail to adhere to the inner surfaces of the cylinder bores are discharged to the outside of the enclosure, which houses the cylinder block, by conducting the exhaust ventilation in the spraying. Thus, it is possible to suppress deterioration in quality of the sprayed coatings 12 and to control the coating thickness at the same time.

Furthermore, according to a sprayed coating forming method according to one or more embodiments of the present invention, the air supplied into the enclosure to house the cylinder block flows around the cylinder block and also flows inside the cylinder bores formed in the cylinder block. As a consequence, it is possible to prevent residual particles and the like, which may scatter in the spraying, from adhering to the sprayed coatings.

Although embodiments of the present invention are described above, the present invention is not limited only to the above-described embodiments. For example, while the order of spraying is determined in the order of the second cylinder bore 6B, the fourth cylinder bore 6D, the first cylinder bore 6A, and the third cylinder bore 6C, the order is not limited only to the foregoing. Meanwhile, in the above-described embodiments, the sprayed coatings 12 are formed in the in-line four-cylinder engine. However, the sprayed coating forming method according to one or more embodiments of the present invention is also applicable to an in-line six-cylinder engine and a V-type engine. In the meantime, the exhaust ventilation may also be conducted from a head block attaching surface side of the cylinder bores 6.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE SIGNS LIST

1 cylinder block
2 spray gun
3 enclosure
6 ( 6A to 6D) cylinder bore
6a inner surface of cylinder bore
11 droplet
12 sprayed coating

1. A sprayed coating forming method of forming a sprayed coating, comprising:
pre-heating a cylinder block defining a plurality of cylinders;
supplying air into an enclosure that houses the cylinder block;
inserting a spray gun sequentially into cylinder bores formed in the cylinder block while discharging the air at least from one side of the cylinder block; and
spraying droplets of a molten metal onto an inner surface of each of the cylinder bores, wherein the spraying comprises spraying one of the cylinder bores first, then next spraying another of the cylinder bores that has at least one of the cylinders disposed between the another of the cylinder bores and the one of the cylinder bores sprayed first, and
wherein the air flows around the cylinder block and also flows inside the cylinder bores.

2. The sprayed coating forming method according to claim 1,
wherein the cylinder bores comprise four cylinder bores sequentially named a first cylinder bore, a second cylinder bore, a third cylinder bore, and a fourth cylinder bore formed in series in the cylinder block, and
wherein the spraying is performed, in order, on (1) the second cylinder bore, (2) sprayed, and then the fourth cylinder bore, (3) the first cylinder bore, and (4) the third cylinder bore.

3. The sprayed coating forming method according to claim 1, wherein, in the spraying, any of residual particles, soot, and splattered droplets that fail to adhere to the inner surface of any of the cylinder bores are discharged to outside of the enclosure that houses the cylinder block by conducting exhaust ventilation.

4. (canceled)
